(19) United States
(12) Patent Application Publication
(10) Pub. No.: US 2006/0124610 A1
(43) Pub. Date: Jun. 15, 2006

(54) Spot welding method, spot welding machine and spot welding robot

(76) Inventor: Masao Nakamura, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/559,335

(22) PCT Filed: May 21, 2004
(86) PCT No.: PCT/JP04/06945

§ 371 Date: Dec. 5, 2005

(30) Foreign Application Priority Data
Jun. 4, 2003 (JP) 2003-159271

(51) Int. Cl. B23K 11/24

(52) U.S. Cl. 219/110

(57) ABSTRACT

A spot welding apparatus capable of detecting a defect such as a missing of works or a bite of a foreign substance reliably before a welding operation.

A spot welding method for welding superposed works (6) which are clamped and pressed between a stationary electrode (3) and a movable electrode (4) and are fed an electric power between the electrodes (3) and (4). The method has the step of: prior to an actual welding operation, measuring a position of the movable electrode (4) when the works (6) are clamped by the electrodes (3) and (4), and storing the measured value as a reference value TH; measuring a position TR of the movable electrode (4) when the works (6) are clamped by the electrodes (3) and (4), at the time of executing the actual welding operation; and comparing the position TR and the reference value TH thereby to execute the welding operation, when the position, TR is within a predetermined range with respect to the reference value TH, and to issue a warning and interrupt the welding operation, when the position TR is not within the predetermined range.

### TECHNICAL FIELD

The present invention relates to a spot welding method and apparatus for welding a superposed work by clamping and pressing the work between a pair of electrodes and by feeding an electric power between the aforementioned electrodes and, more particularly, to a method and apparatus for detecting the missing of a work or the bite of a foreign substance automatically.

### BACKGROUND ART

The spot welding for welding a superposed work by clamping and pressing the work between the paired electrodes and by feeding the electric power between the aforementioned electrodes is frequently used in the field for assembling a chassis of an automobile or the like. Especially in recent years, there is widely spread the spot welding apparatus and the spot welding robot for executing the spot welding automatically by attaching, in place of a pneumatic device, the electric spot welding gun having its electrodes driven and pressed by a servomotor, to an industrial robot.

In an automatic line using the spot welding robot, the work is assembled at an upstream step and is fixed by a jig so that it is transferred to a spot welding step. If the work is not correctly fixed, if parts to be assembled are missing or if a foreign substance is bitten, for some cause, these defects are overlooked because of an unmanned line to raise a problem that the spot welding is carried out as it is and transferred to a downstream step.

In order to solve this problem, there has been proposed an invention (e.g., Patent Publication 1 or Patent Publication 2) of the spot welder for detecting an abnormality of the missing of the work by determining the resistance between the electrodes, at the time when the work is clamped between spot welding electrodes, according to the magnitude of the resistance.
Patent Publication 1: Japanese Patent Unexamined Publication No. JP-A-2000-254786
Patent Publication 2: Japanese Patent Unexamined Publication No. JP-A-2001-138063

### DISCLOSURE OF THE INVENTION

However, the method utilizing the resistance between the electrodes has a problem that the power conducting area is changed by the wear of the electrodes so that the resistance for a plate thickness changes to make the precise decision impossible. Further, since the resistance is measured after the work was pressed, the nuggets are formed on the surface of the work. As a result, the resistance changes to raise a problem that the NG products are made even if the welding is tried again by removing the defects.

Therefore, the invention has an object to provide a spot welder capable of detecting a defect such as a missing of a work or a bite of a foreign substance reliably before a welding operation.

Means for Solving the Problems

In order to solve the aforementioned problems, according to the invention, there is provided a spot welding method for welding superposed works which are clamped and pressed between a stationary electrode and a movable electrode and are fed an electric power between the electrodes, characterized in that the spot welding method comprises the steps of: prior to an actual welding operation, measuring a position of the movable electrode when the works are clamped by the electrodes, and storing the measured value as a reference value;

measuring a position of the movable electrode at the time when the work is clamped by the electrodes, at the time of executing the actual welding operation; and comparing the position and the reference value to thereby execute the welding operation, when the position is within a predetermined range with respect to the reference value, and to issue a warning and interrupt the welding operation, when the position is not within the predetermined range.

Effects of the Invention

As has been described hereinbefore, the effect is that the plate thickness of the work is detected with reference to the travel of the movable electrode so that the defect such as the missing of the work can be reliably detected. Moreover, a dedicated hardware such as a dedicated sensor can be dispensed with so that the defect can be detected simply and inexpensively to improve the reliability of the spot welding robot.

### BRIEF DESCRIPTION OF THE DRAWING

FIG. 1 A conceptional diagram of a spot welding gun to be used for executing the present invention.

### DESCRIPTION OF REFERENCE NUMERALS AND SIGNS

1 SPOT WELDING GUN
2 FRAME
3 STATIONARY ELECTRODE
4 MOVABLE ELECTRODE
5 SERVOMOTOR
6 WORK

### BEST MODE FOR CARRYING OUT THE INVENTION

An embodiment of the present invention is specifically described in the following with reference to the accompanying drawing.

### EMBODIMENT 1

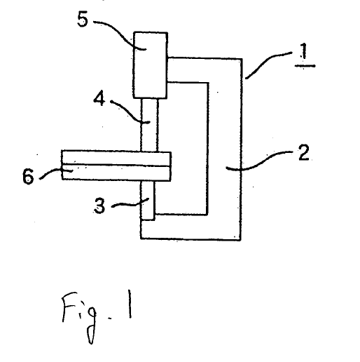

FIG. 1 is a conceptional diagram of a spot welding gun and shows the embodiment of the present invention. In the Drawing, numeral 1 designates a spot welding gun. The spot welding gun 1 is integrally assembled with the not-shown transformer, and is attached to the leading end of the not-shown robot so that it is moved to a position, which is programmed in a control device of the aforementioned robot, thereby to execute the spot welding.

Numeral 2 designates the frame of the spot welding gun 1, and a stationary electrode 3 is attached to the lower portion of the frame whereas a movable electrode 4 is attached to the upper portion. The movable electrode 4 is driven by a servomotor 5 so that it is moved upward and downward to clamp and press a work 6 between itself and the stationary electrode 3. The servomotor 5 is controlled as an additional shaft of the aforementioned robot by the aforementioned control device of the robot so that the movable electrode 4 is freely controlled in its position, speed and thrust (or pressing force)

Next, a spot welding method according to the spot gun 1 is described. The spot welding method of the present invention is divided into the “plate thickness measuring” step and the “testing” step.

(Plate Thickness Measurement)

(1) A reference work is set with a jig. The reference work is a work to be actually worked, and has been confirmed that there are not any missing of parts nor the bite of a foreign substance therein.

(2) The robot control device is switched from the “play mode” to the “utility mode” to select the “plate thickness measurement”.

(3) A welding job (program) is executed. The “utility mode” and the “plate thickness measurement” are selected. In this case, the actual welding is not performed, in stead, the plate thickness measurement is actually executed for each dot.

(4) The plate thickness measurement is carried out so as to measure a position ( )TH which the movable electrode 4 abuts against the work 6. Specifically, the TH is determined by counting the pulse number of an absolute encoder indicating the rotational angle of the servomotor 5 and by multiplying that pulse number by a predetermined coefficient. The TH corresponds to the travel covered from the position of the movable electrode 4 corresponding to the zero point of the whole encoder to the position abutting against the work 6. The TH is used as a reference value at the “testing” step.

(5) Next, the allowable range (THA) of the aforementioned position (TH) at each dot is set as a percentage to the TH. Specifically, determining the existence of the defect of the work or the bit of the foreign substance, if the TH fluctuates beyond the range of ±THA %.

(6) The TH and the THA are stored at each dot in the robot control device.

(Test)

The test is carried at each dot when the job is carried out in a playback mode. Here, the wears of the stationary electrode 3 and the movable electrode 4 causes problems. This is because the movement of the movable electrode 4 increases as the electrode wears. Therefore, the wear of the electrode is measured periodically, e.g., at every 100 dots. The measurement of the wear can be simply determined by shooting the spot gun 1 idly without clamping the work 6 in the spot gun 1 and by comparing the action of the movable electrode at the time, when the stationary electrode 3 and the movable electrode 4 abut against each other, with that before the wear. This wear will be expressed by DMF in the following.

Now, the test is carried out in the following procedure.

(1) The stationary electrode 3 is brought into abutment against the back surface of the work 6.

(2) The movable electrode 4 is activated to abut against the front surface of the work 6, and the position (TR) of the movable electrode 4 at this time is determined. Like the TH, the TR is determined by multiplying the pulse number of the absolute encoder by a predetermined coefficient.

(3) The value (TR−DMF), which is prepared by correcting the position TR with the wear, is determined and is compared with the position (or the reference value) TH at the plate thickness measuring time.

(4) In case the value of TR-DMF is larger than TH*(100+THA)/100, it is decided that the existence of missing of any works, and the spot welding is interrupted to issue a warning.

(5) In case the value of TR-DMF is smaller than TH*(100+THA)/100, it is decided that the existence of bitten the foreign substance in the work, and the spot welding is interrupted to issue a warning.

(6) When the worker, who received the aforementioned warning, removes the defect such as the missing of the work, the worker releases the warning and reopens the spot welding operation.

The “plate thickness measurement” and the “test” are executed on the software in the control device of the robot, but may be executed by a control device of a welding power source. Moreover, if the pressing force of the movable electrode 4 in the “plate thickness measurement” and the “test” is selected a lower value than that of the actual welding, it is possible to prevent the nugget from occurring on the work 6.

### INDUSTRIAL APPLICABILITY

The plate thickness of the work is detected with reference to the travel of the movable electrode so that the defect such as the missing of the work can be reliably detected, and the present invention can find its application to a spot welding robot dispensing with a dedicated hardware such as a dedicated sensor.

1. A spot welding method for welding superposed works which are clamped and pressed between a stationary electrode and a movable electrode and are fed an electric power between the electrodes, the spot welding method comprising the steps of:
prior to an actual welding operation, measuring a position of the movable electrode when reference works are clamped by the electrodes, and storing the measured value as a reference value;
measuring an actual position of the movable electrode at the time when the works are clamped by the electrodes, at the time of executing the actual welding operation and before feeding the electric power between the electrodes; and
comparing the actual position and the reference value to thereby feed the electric power between the electrode so as to execute the welding operation, when the position is within a predetermined range with respect to the reference value, and to thereby issue a warning and not to feed the electric power between the electrodes so as to interrupt the welding operation, when the position is not within the predetermined range.

2. A spot welding apparatus for welding superposed works which are clamped and pressed by a stationary electrode and a movable electrode and are fed an electric power between the electrodes, the welding apparatus comprising:
a storing unit measuring a position of the movable electrode when the reference works are clamped by the electrodes and storing the measured value as a reference value, prior to an the actual welding operation;
a measuring unit measuring an actual position of the movable electrode at the time when the works is clamped by the electrodes, at the time of executing the actual welding operation and before feeding the electric power between the electrodes; and
a comparing unit which compares the actual position and the reference value to thereby feed the electric power so as to execute the welding operation, when the position is within a predetermined range with respect to the reference value, and to thereby issue a warning and not to feed the electric power between the electrodes so as to interrupt the welding operation, when the position is not within the predetermined range.

3. A spot welding robot characterized in that the spot welding apparatus as set forth in claim 2 is attached to a leading end of an arm thereof.
